(19) United States
(12) Patent Application Publication
(10) Pub. No.: US 2024/0049697 A1
(43) Pub. Date: Feb. 15, 2024

(54) CONTROL FILE FOR A TREATMENT SYSTEM

(71) Applicant: BASF AGRO TRADEMARKS GMBH, Ludwigshafen (DE)

(72) Inventors: Hubert SCHMEER, Köln (DE); Carvin Guenther SCHEEL, Köln (DE); Marcel Enzo GAUER, Köln (DE); Steffen TELGMANN, Köln (DE); Clemens Christian DELATREE, Münster (DE); Matthias GERBER, Ludwigshafen (DE); Holger HOFFMANN, Köln (DE); Johannes Moritz STAEBLER, Köln (DE)

(21) Appl. No.: 18/278,924

(22) PCT Filed: Mar. 3, 2022
(86) PCT No.: PCT/EP2022/055401

§ 371 Date: Aug. 25, 2023

(30) Foreign Application Priority Data
Mar. 5, 2021 (EP) 21161055.5

(51) Int. Cl. A01M 7/00; A01M 21/04

(52) U.S. Cl. CPC A01M 7/0089; A01M 21/043

(57) ABSTRACT

A method for generating a control file to operate a treatment device (10) on an agricultural area (11) to be treated, the method comprising the steps of: providing (40) treatment data signifying a type of treatment to be conducted by the treatment device and crop data relating to a crop present on the agricultural area (11) to be treated to a preparation system (13); determining (42), by the preparation system (13), from the treatment data and the crop data at least one operation parameter, wherein the determined operation parameter is related to a real-time and/or location-specific condition to be monitored during treatment; generating (44), by the preparation system (13), a control file comprising the at least one operation parameter, the generated control file usable to operate the treatment device (10) based on the real-time and/or location-specific condition to be monitored during treatment.

The present disclosure relates to a method for generating a control file to operate a treatment device on an agricultural area, respective control file preparation systems, treatment devices, computer program products and machine-readable storage devices.

### BACKGROUND

The general background of this disclosure is the treatment of plants in an agricultural area, which may be an agricultural field, a greenhouse, or the like. The treatment of plants, such as the cultivated crops, may also comprise the treatment of weeds present in the agricultural area, the treatment of the insects present in the agricultural area or the treatment of pathogens present in the agricultural area.

A semi-automated or fully automated plant treatment device, such as a robot, a smart sprayer, or the like, may be configured to treat the weed, the insects and/or the pathogens in the agricultural area based on ecological and economical rules. In order to automatically detect and identify the different objects to be treated, image analysis techniques, such as image recognition, may be used. For this purpose, the treatment device may carry an image capture device, such as a camera or the like. Further, for the actual plant treatment during operation, the treatment device may carry plant treatment means, such as spray nozzle, a tank, control means, etc. Controlling operation of the treatment device may be based on a decision logic, which may comprise e.g. a data processing unit and/or a control software etc., that is configured to obtain the images taken and to decide whether or not to treat an area of interest of the agricultural area.

WO2018208947A1 for instance discloses a plant treatment platform using a plant detection model to detect plants as the plant treatment platform travels through a field. The plant treatment platform applies the plant detection model to the pre-processed image data to generate bounding boxes for the plants. The plant treatment platform then can apply treatment to the plants based on the output of the machine-learned model.

EP3576526A1 discloses a weed control system for an agricultural sprayer comprising a camera and a spraying unit with several supply modules, a nozzle and a controller module to receive a weed species detection signal and to command the spraying of chemical agent. The weed control system also comprises a weed species identification unit with a communication module, a memory module and a processing module having several parallel processing cores.

WO2019226869A1 describes a farming machine including a number of treatment mechanisms treats plants according to a treatment plan as the farming machine moves through the field. The control system of the farming machine executes a plant identification model configured to identify plants in the field for treatment.

In existing systems, processing of the image and the treatment decision are computed on the fly while the system traverses through the field. Such computation may be time consuming and reduces the speed of travel, which makes such approaches more time consuming and economically less attractive despite potential saving on the treatment product. If the computational efforts are reduced to counter act this effect, accuracy of the decision may suffer.

WO2020201163A1 describes determining an application rate decision logic based on offline field data relating to expected conditions on the plantation field; taking an image of a plantation of a plantation field; recognizing objects on the taken image; determining an application rate based on the determined application rate decision logic and the recognized objects; and determining a control signal for controlling a treatment arrangement of a treatment device based on the determined application rate. A drawback of this approach is a relatively low accuracy of treatment and particularly a relatively inflexible treatment.

### SUMMARY OF THE INVENTION

Therefore, there is a need to provide means for improving plant treatment, particularly in terms of speed and accuracy. It is accordingly an object of the present invention to provide more efficient and/or effective means for treating plants. This object is solved by the subject-matter of the independent claims.

According to a first aspect, provided herein is a method for generating a control file to operate or control a treatment device on an agricultural area to be treated, the method comprising the steps of:
providing crop data relating to a crop present on the agricultural area to be treated and treatment data signifying a type of treatment to be conducted by the treatment device, and optionally environmental data related to the agricultural area to be treated, to a preparation system, preferably a remote computing resource communicatively coupled to the treatment device;
determining, by the preparation system, from the crop data and the treatment data, and optionally the environmental data, at least one operation parameter, wherein the determined at least one operation parameter is related to a real-time and/or location-specific condition to be monitored during treatment, e.g. by the treatment device, preferably wherein based on the operation parameter and the condition to be monitored a treatment component of the treatment device is to be operated in a specific operation mode;
generating, by the preparation system, a control file comprising the determined at least one operation parameter, the generated control file usable to operate the treatment device based on the real-time and/or location-specific condition to be monitored during treatment e.g. by the treatment device.

According to another aspect, provided herein is a method for providing a control file to a treatment device, the method comprising the steps of:
generating a control file according to the method lined out above;
providing, via an interface, e.g. a data interface and/or communication interface or the like, the control file to the treatment device prior to treatment of the agricultural area.

According to another aspect, provided herein is a method for operating a treatment device on an agricultural area, the method comprising the steps of:
providing, via an interface, e.g. a data interface and/or communication interface or the like, a control file generated and/or provided according to the methods lined out above to a control system;
monitoring a real-time and/or location-specific condition e.g. by the treatment device; and
operating or controlling, via the control system, the treatment device during treatment of the agricultural area based on the provided control file and a real-time and/or location-specific condition monitored e.g. by the treatment device.

According to another aspect, provided herein is a preparation system for generating and/or providing the control file to operate or control the treatment device on the agricultural area. The preparation system is configured to perform the methods for generating and/or providing a control file via an interface as lined out above.

According to another aspect, provided herein is a treatment device for applying a treatment, preferably a treatment product, to an agricultural area, the treatment device comprising:
an interface, e.g. a data interface, communication interface or the like, configured to provide a control file generated and/or provided as lined out above to a control system of the treatment device;
at least one monitoring component configured to provide a real-time and/or location-specific condition; and
the control system communicatively coupled to the at least one monitoring component, wherein the control system is configured to operate or control the treatment device during treatment of the agricultural area based on the provided control file and the real-time and/or location-specific condition.

According to another aspect, provided herein is a system configured to operate or control the treatment device including the treatment device and the preparation system as lined out above. According to another aspect, provided herein is a control system configured to operate the treatment device based on the generated and/or provided control file as lined out above.

According to another aspect, provided herein is a computer program element or a control program element, which when executed on a computing device or the control system, is configured to operate the treatment device as lined out in the methods above, in particular based on the control file generated and/or provided as lined out in above methods. In yet a further aspect the disclosure relates to a machine-readable storage device with executable instructions, which when executed on a computing device or the control system, is configured to operate the treatment device as lined out above, in particular based on the control file generated and/or provided as lined out in above methods.

In yet a further aspect the disclosure relates to the use of the control file generated as lined out by above methods for operating or controlling a treatment device. In yet a further aspect the disclosure relates to the use of the control file generated and/or provided as lined out by the methods above in a treatment device.

According to another aspect, provided herein is a data structure comprising a control file generated according to any implementations of the method of the first aspect for operating a treatment device or a control system of a treatment device.

According to another aspect, provided herein is a control system communicatively coupled to the at least one monitoring component, wherein the control system is configured to operate the treatment device during treatment of the agricultural area on a provided control file and the real-time and/or location-specific condition, the control file generated according to any implementations of the method of the first aspect for operating a treatment device or a control system of a treatment device.

Using an operation parameter generated for the agricultural area prior to treatment allows for speed while maintaining accuracy. In particular, the determination of the operation parameter prior to treatment and separate from the treatment device's real-time control allows for computationally heavy modelling or distributed data access without sacrificing accuracy of the treatment operation. Thus, the processing load during treatment is reduced, while accuracy of the treatment decision can be improved.

Any disclosure and embodiments described herein relate to the methods, the preparation system, the treatment device, the control system, the computer program product or machine-readable medium lined out above and vice versa. Advantageously, the benefits provided by any of the embodiments and examples equally apply to all other embodiments and examples and vice versa. These and other embodiments of the present invention will become apparent from and elucidated with reference to the embodiments described hereinafter. As used herein “determining” also includes “initiating or causing to determine” and “generating” also includes “initiating or causing to generate”.

As used herein, the agricultural area to be treated may be any plant or crop cultivation area, such as a field, a greenhouse, or the like. A plant may be a crop, a weed, a volunteer plant, a crop from a previous growing season, a beneficial plant or any other plant present on the agricultural area. The agricultural area may be identified through its geographical location or geo-referenced location data. Here a reference coordinate, a size and/or a shape may be used to further specify the agricultural area.

Data related to the agricultural area may be stored in a data base and accessible through or to the preparation system. The treatment data may relate to past and planned treatments. The crop data may relate to crop currently present on the agricultural area or in previous seasons present on the agricultural area. The crop data, optionally treatment data and optionally environmental data may be stored in one or more data base(s) and may accessible through or to the preparation system. The one or more data base(s) and/or the preparation system may be part of a farm management system. The data base(s) may be a distributed data base or storage associated with the preparation system. The crop data relating to crop currently present on the agricultural area or in previous seasons present on the agricultural area and/or the treatment data relating to past and planned treatments, and optionally environmental data specific to the agricultural area to be treated may be stored in or retrievable from such data base.

As used herein, the preparation system may be a remote computing resource communicatively coupled to the treatment device. The preparation system may be communicatively coupled to or include the one or more data base(s) storing data related to the agricultural area. The preparation system may be remotely located from the treatment device. The preparation system may be communicatively coupled to the treatment device via e.g. a wired or wireless communication channel such as a wireless communication network optionally in combination with a Wireless Local Area Network (WLAN) associated with the treatment device or in combination with a cellular network or a global area network.

The communication channel between the preparation system and the treatment device may be available prior to treatment of the agricultural area. For instance, the communication channel may be a wireless channel for transferring data or the control file between the preparation system and the treatment device. Such communication channel may be available prior to treatment of the agricultural area. In some instances, the communication channel may be activated prior to treatment of the agricultural area to transfer the control file from the preparation system to the treatment device. In other instances, the communication channel may be activated or available during treatment of the agricultural area to provide or update the control file during treatment. In yet other instances, the communication channel may be activated or available during treatment of the agricultural area to provide operational data collected by the treatment device during treatment. Such operational data may include device specific data such as activation signals for spray nozzles, composition data for the treatment product applied, or any measurement recorded during treatment by the treatment device.

As used herein, the control file is a file that includes parameters, preferably parameters specific to the agricultural area, that influence the operation of the treatment device. The control file is suitable or usable for the control system of the treatment device to derive control signals. As such the control file includes information required by the treatment device for real-time and/or location specific operation, in particular tailored to the specific agricultural field. The control file may be binary file including a digital representation of parameters usable for treatment operation on the agricultural area. It may comprise at least one operation parameter relating to the treatment operation of the treatment device. In particular, the operation parameter may be related to a real-time and/or location-specific condition monitored or measured during treatment e.g. by the treatment device. The operation parameter may be a threshold value relating to the real-time and/or location-specific condition monitored or measured during treatment. The threshold value may relate to an absolute or relative quantity derived from the monitored real-time and/or location-specific condition. Depending on the derived quantity being less than, equal to or greater than the threshold value the treatment device may be operated in a specific operation mode.

The control file may be implemented via a one or multi-dimensional look up table or a multi-dimensional decision tree assigning an operation parameter to a real-time and/or location-specific condition monitored or measured during treatment e.g. by the treatment device. For instance, the control file may be implemented via a one or multi-dimensional look up table or a multi-dimensional decision tree assigning thresholds to weed coverage values derived from an image recorded during treatment. The control file may include further logic layers relating to different real-time and/or location-specific conditions monitored or measured during treatment. Such logic layers may include weed species/types, crop type, weed growth stage or crop growth stage.

The operation mode may hence be controlled in real-time and/or location-specific. In other words, monitoring the real-time and/or location-specific condition; deriving a quantity from the monitored real-time and/or location-specific condition; and based on the operation parameter and the monitored condition or its derived quantity determining a control signal for real-time and/or location-specific operation of the treatment device may be executed during treatment by the treatment device based on the control file. Examples of operation modes may comprise one or more flat rate or broadcast operations in which the same quantity of a treatment product is applied over a defined total area across multiple or all treatment components, a variable rate application (VRA) operation in which, e.g. based on a map, a first quantity of a treatment product is applied over multiple sub-areas, such as a first subarea, a second subarea, etc., and/or or a simple activation or deactivation of the individual treatment components is performed on the spot e.g. for spot spraying. Any such operation mode may be performed by providing a corresponding control parameter set with respective control signal(s) for e.g. individual treatment components depending on the provided control file. Further, different operation modes may correspond to different application rates of the treatment product for one or more of the treatment component(s).

As used herein, the treatment may relate to a chemical, mechanical or electrical treatment. The term “treatment product” is understood to be any object or material useful for the treatment. In the context of the present invention, the term “treatment product” includes but is not limited to:
chemical products such as fungicide, herbicide, insecticide, acaricide, molluscicide, nematicide, avicide, piscicide, rodenticide, repellant, bactericide, biocide, safener, plant growth regulator, urease inhibitor, nitrification inhibitor, denitrification inhibitor, or any combination thereof.
biological products such as microorganisms useful as fungicide (biofungicide), herbicide (bioherbicide), insecticide (bioinsecticide), acaricide (bioacaricide), molluscicide (biomolluscicide), nematicide (bionematicide), avicide, piscicide, rodenticide, repellant, bactericide, biocide, safener, plant growth regulator, urease inhibitor, nitrification inhibitor, denitrification inhibitor, or any combination thereof.
fertilizer and nutrient,
seed and seedling,
water, and
any combination thereof.

A treatment product may relate to a chemical treatment product that may be applied to the agricultural area for plant treatment. Treatment indications may be weeds, fungi, insects or nutrient content. Products may comprise one or more of herbicide, pesticide, insecticide, fungicide, plant growth regulator, nutrient or the like.

As used herein, crop present on the agricultural area refers to crop grown, and/or sown, and/or planned to be grown or sown on the agricultural area. The crop may relate to crop grown or sown in earlier seasons, the present season, in which treatment is to be conducted, or the upcoming season.

As used herein, real-time refers to an operation that is conducted during treatment of the agricultural area. Real-time operation may hence include monitoring and treating of the agricultural area while the treatment device traverses through the agricultural area. In other words, real-time may refer to online operations conducted during treatment or while the treatment device traverses through the agricultural area.

As used herein, location-specific refers to a space resolution that is smaller than the area of the agricultural area. Location-specific may include space resolutions in the range of multiple hundred meters to a couple of millimeters, preferred a couple of meters to a couple of centimeters and more preferred multiple centimeters e.g. in the range of 1-300 cm, in the range of 10 to 200 cm, or in the range of 20 to 150 cm. Location-specific may refer to a sub-area or a geographical location or location coordinate of a sub-area of the agricultural area. Such geographical location or location coordinate may be associated with the condition monitored or the treatment conducted in the sub area such location is associated with. The geographical location or location coordinate may be attached to the monitored condition and/or the conducted treatment and optionally be stored as metadata together with the monitored condition and/or the conducted treatment.

As used herein, the treatment device may be part of a smart farming machinery and may preferably be part of a distributed computing system. The treatment device may be a driving, flying or any otherwise moving device configured to travel through or over the agricultural area, e.g. via a ground vehicle, a rail vehicle, an aircraft, a drone, or the like. Further, the smart farming machinery or the treatment device may include, for example, a vehicle, an aircraft, a robot, a sprayer, or the like, with one or more treatment mechanisms attached and may comprise a communication and/or connectivity system. The connectivity system may be configured to communicatively couple the smart farming machinery or treatment device to the distributed computing environment. It may be configured to provide a control file generated via remote computing resources of the distributed computing system to the smart machinery or treatment device or to provide data collected on the smart machinery or treatment device to one or more remote computing resources of the distributed computing system.

In one embodiment the treatment device includes one or more treatment component(s), such as spray nozzle(s) for chemical treatment, electric discharger(s) or electromagnetic treatment means like laser, mechanical gripper(s) for mechanical treatment or a combination thereof, to allow for targeted treatment. In case of chemical treatment, the treatment device may include one or more spray nozzle(s) to release treatment product to the agricultural area, such as a field for cultivating crop.

Furthermore, the treatment device may comprise one or more monitoring component(s), such as image capture device(s) like camera(s), which are configured to take data, such as images, of the agricultural area as the treatment device travels through the agricultural area. The data may be measurement or monitoring data related to the condition to be monitored. The monitoring component(s) may be configured to monitor a condition on the agricultural area in real-time and/or location-specific. The monitoring component(s) may be associated with the treatment component(s), such that the area of interest captured by one monitoring component is associated with the area of interest to be treated by one or more treatment component(s).

Depending on the control file and the real-time and/or location-specific monitored by the monitoring component(s) the treatment component(s) associated with the respective monitoring component(s) may be selectively activated. The monitoring component(s) may be LI DAR sensor(s). The monitoring component(s) may be camera(s) attached to the treatment device. The one or more camera(s) may be RGB cameras, hyperspectral cameras, near infrared cameras or other suitable optical measurement devices. Each image captured in such a way may be associated with a location and as such provide a snapshot of the real time situation in the location of the agricultural area to be treated. Such set up enables a real time, location-specific control of the treatment device by activating the treatment component(s) associated with the camera(s) depending on such snapshot of the real time situation in the location of the agricultural area to be treated.

Furthermore, the treatment device may comprise a positioning system providing positioning data signifying the position of the treatment device during treatment. Such positioning system may include a GPS system providing a geographical location of the treatment device. Depending on the set up of the treatment device such positioning data may be used to assign a geographical location or location coordinate to the condition monitored or the treatment conducted. Here one geographical location or location coordinate may be attached to all treatment component(s) or the geographical location or location coordinate may be attached to individual treatment component(s). The geographical location or location coordinate may be attached to the monitored condition and/or the conducted treatment and optionally be stored as metadata together with the monitored condition and/or the conducted treatment.

Further, as used herein, crop data, optionally treatment data and optionally environmental data may be specific to the agricultural area or may relate to specific characteristics of the agricultural area to be treated. Crop data, optionally treatment data and optionally environmental data may be associated with subarea-specific, such as zone-specific or location-specific, characteristics of the agricultural area. Further crop data, optionally treatment data and optionally environmental data may be associated with historic data collected for the agricultural area and stored e.g. by the farm management system.

Crop data may include a specification of the crop cultivated on the agricultural area. In particular crop data may include at least one of a crop type indicator, a crop trait indicator, a crop planting density and crop growth stage data. Crop growth stage data may signify at least one crop growth stage related to the timing of the planned treatment. Crop type indicator may signify the cultivar of the crop, like maize, corn or sugar beet, and/or a variety. A crop trait indicator may signify genetic characteristics of the crop, such as genetically modified, herbicide tolerant or conventional crop. Treatment data may include a specification of a treatment plan including for instance treatment product(s) specification, treatment product characteristic(s) and/or treatment timing in relation to the treatment product(s) specification or a treatment sequence in case of more than one treatment to be conducted. The treatment sequence may include on one or more treatment product(s) with associated treatment timing(s) and/or characteristic(s). Environmental data may include historic weather data, forecasted weather data or historic measurement data relating to conditions on the agricultural area to be treated. Such data may be associated with location-specific conditions or treatments on the agricultural area. Environmental data may include non-real-time recorded data and/or real-time recorded data, such as data from remote sensing equipment e.g. satellites, data from stationary equipment placed in the agricultural area, e.g. weather stations, soil sensors or the like, and/or data from sensors of the treatment device, e.g. condition monitoring sensors, images, temperature sensors, weather sensors, fluidic sensors, or the like.

In one embodiment crop data, optionally treatment data and optionally environmental data may be provided via a farm management system. The system may store data related to the agricultural area to be treated. In particular, the farm management system may store data relating to the location of the agricultural area. In other words, such data may relate to the area as such, to sub-areas of the agricultural areas and/or to specific locations of the agricultural area.

In a further embodiment the operation parameter relates to the condition monitored, e.g. an image taken, during treatment of the agricultural area e.g. by the treatment device or a parameter derivable from the condition monitored. This parameter may be a relative parameter, which may refer to a dimensionless parameter or a percentage. During treatment a real-time parameter may be derived from monitored conditions and the relation, e.g. comparison, to the operation parameter may influence the control signals of the treatment device. In a preferred embodiment the operation parameter may be a threshold related to a fraction of an image comprising objects to be treated. Such objects may relate to weeds, insects or diseases detected on an image. The operation parameter may control the treatment component of the treatment device based on a real-time, preferably location-specific, condition monitored by at least one monitoring component of the treatment device.

For instance, in weed treatment the threshold may relate to a fraction of weed objects present on an image. For insect treatment the threshold may relate to a fraction of insects present on the image. For disease treatment the threshold may relate to a fraction of fungal infestation present on the image. Here the fraction of pixels associated with weed, insect or fungal infestation may be derived from the image. For a percentage parameter the fraction of pixels associated with weeds, insects or fungal infestation may be related to all pixels or pixels not associated with weed, insect or fungal infestation. In operation of the treatment device, this may be calculated e.g. by the number of pixels assigned to weeds, insects, fungal infestation compared to the total number of pixels of the image. If the fraction is greater than or equals the threshold, an operation mode, such as an on-signal for the treatment component associated with the monitoring component, may be triggered.

In a further embodiment, visible plant damage due to plant pathogenic bacteria or viruses may be derived from the image and pathogenic bacteria or viruses infestation may be determined.

In a further embodiment the operation parameter for a crop type indicator, preferably as provided by crop data, and a treatment plan, preferably as provided by treatment data, is determined based on a crop growth data optionally to provide a basic operation parameter. The crop type indicator, the treatment plan and/or the crop growth data may be assigned to the agricultural area to be treated. The crop type indicator may refer to e.g. corn, sugar beet or specific varieties. The treatment plan may include a date or timing of treatment, the treatment product, a treatment mode, e.g. one or a sequence of treatment(s). The crop growth data relates to crop growth stage, which may be calculated for the timing of the planned treatment via a crop growth stage model. A crop growth model may determine the crop growth stage based on the timeframe between sowing of the crop to the timing of the planned treatment and weather data. The crop growth stage may be determined from measurement data recorded prior to the timing of the planned treatment. Here the latest measurement data recorded or available prior to the timing of the planned treatment may be used. Potential measurements may be provided by images of the crop and respective image analysis to determine the crop growth stage. Crop growth stage may be determined in terms of BBCH.

In a further embodiment the determination of the operation parameter includes the determination of a basic operation parameter and/or an adjusted operation parameter. Optionally the basic parameter may be determined based on crop type indicator and crop trait indicator. The basic parameter determination may further dependent on crop growth data and/or treatment data, such as treatment product specification and timing of treatment product application. The basic operation parameter may be determined, by the preparation system, dependent on plant growth data such as crop and/or weed growth data. Dependent on the environmental data an adjusted operation parameter may be determined via the preparation system. For adjustment absolute or relative values may be used. For instance, at least one adjustment parameter may be used to increase or decrease the basic operation parameter by an adjustment value, thereby forming the adjusted operation parameter. The control file comprising the basic operation parameter and the adjustment value or comprising the adjusted operation parameter, both usable to operate the treatment device based on a real-time and/or location-specific condition to be monitored e.g. by the treatment device, may generated.

In addition to the crop type indicator and the crop trait indicator, the crop growth data assigned to the agricultural area to be treated and related to the timing of treatment, preferably as provided by the treatment data, may be used to provide a basic operation parameter. In other word the basic parameter may be determined based on crop growth data assigned to the agricultural area to be treated and the timing of treatment, preferably as provided by the treatment data. The basic or adjusted operation parameter may be location-specific to provide a map of basic or adjusted operation parameters. Such basic setting allows for treatment product savings dependent on the crop growth stage and in particular at later crop growth stages. For instance, in weed treatment the threshold may be set higher for later crop growth stages than for early crop growth stage. By changing the threshold in the control file according to the crop growth stage a finer and more tailored treatment can be conducted saving treatment product particularly at later crop growth stages.

In a further embodiment meta data associated or specific to the agricultural area is used to initiate generation of the basic or adjusted operation parameter. Here metadata associated with the user and/or the agricultural area may signify that the agricultural area to be treated is registered with a service for basic or advanced operation providing basic or adjusted operation parameter generation, respectively.

In a further embodiment the operation parameter is determined or adjusted based on precipitation data and treatment product characteristic(s) as e.g. provided by the treatment data. The treatment product characteristic may relate to a residual characteristic and/or an efficacy characteristic. In combination with precipitation data such treatment product characteristic may be related to the agricultural area to be treated. This way effects from prior or planned treatment(s) with respective treatment product(s) may be included into the determination or adjustment of the operation parameter. For instance, treatment products such as soil-applied or residual herbicides may be activated by precipitation or precipitation may influence the efficacy of treatment products like fungicides. Hence the precipitation data may be used to provide an advanced operation parameter setting. Historic precipitation data from historic weather data or forecasted precipitation data from forecasted weather data may be used as precipitation data.

To determine or adjust the operation parameter with respect to prior treatment(s) historic precipitation data may be used. In such case historic precipitation including data from previous growing seasons may be compared to historic precipitation data including data from a timeframe in the current growing season to determine, if the current season is a wet or dry season. Depending on such determination the operation parameter may be determined or adjusted. In other words, the operation parameter may be determined or adjusted to take effects of precipitation and prior treatments into account. Here historic may refer to prior growing seasons or any time frame prior to the planned treatment.

For instance, in weed treatment residues from residual herbicides of earlier treatments can play a role. The operation parameter may be adjusted, specifically the threshold may be set higher than the basic threshold, if historic precipitation data from prior growing seasons signifies a higher amount of precipitation than in the current season. This way the effect of prior treatment(s) with residual treatment products that may not have been activated may be accounted for. Such prior treatment(s) may be provided via the treatment data. Similarly, the operation parameter may be determined adjusted, specifically the threshold may be set lower than the basic threshold, if historic precipitation data from prior growing seasons signifies a lower amount of precipitation than in the current season. By changing the operation parameter in the control file to take effects like activation of prior treatments into account, a finer and more tailored treatment can be conducted saving treatment product and reducing the impact on the environment.

In the case of forecasted precipitation data, the operation parameter may be determined or adjusted based on a forecasted precipitation after the treatment to be conducted and treatment product characteristics e.g. as provided by the treatment data. Such adjustment may depend on the treatment product characteristic of the treatment product to be applied, such as residual or non-residual product. For instance, in weed treatment activation of residual herbicides may be considered. For residual treatment products, the operation parameter may be determined or adjusted, specifically the threshold may be set lower than the basic threshold or to apply no treatment product, if forecast precipitation data signifies precipitation to be below a set amount of precipitation. Similarly, the operation parameter may be determined or adjusted, specifically the threshold may be set higher than the basic threshold, if forecast precipitation data signifies precipitation to be above a set amount of precipitation. Additionally or alternatively, the operation parameter may be determined or adjusted for non-residual treatment products, if forecast precipitation data signifies precipitation to be above or below a set amount of precipitation.

In a further embodiment the operation parameter is determined based on one or more in-season treatment indicator(s) relating to one or more treatment(s) of the agricultural area or relating to the plant, insect or disease spectrum present or expected to be present on the agricultural area. Such indicators may relate to treatments such as ploughing or the use of slurry or farmyard manure. Furthermore, such indicators may relate to cover crop indicators or volunteer plant indicators. Based on such in season or out of crop season indicators the operation parameter may be adjusted once, if one of them is fulfilled. This way the operation parameter includes such indicators and allows for a targeted and effective treatment.

In one embodiment the basic parameter is determined based on crop type indicator or a crop trait indicator related to the agricultural area, and the adjusted operation parameter is determined based on plant growth data related to the agricultural area, precipitation data related to the agricultural area, one or more treatment product characteristic(s), at least one in-season treatment indicator relating to at least one treatment of the agricultural area or weed, insect or disease spectrum present on the agricultural area.

In a further embodiment the generation of an adjusted operation parameter includes:
wherein precipitation data related to the agricultural area to be treated is provided to the preparation system, wherein the adjusted operation parameter is determined based on precipitation data and one or more treatment product characteristic(s),
wherein at least one in-season treatment indicator relating to at least one treatment of the agricultural area is provided to the preparation system, wherein the adjusted operation parameter is determined based on the in-season treatment indicator, or
wherein weed, insect or disease spectrum present on the agricultural area is provided to the preparation system, wherein the adjusted operation parameter is determined based on weed, insect or disease spectrum.

In a further embodiment the operation parameter for weed treatment is determined based on critical weed species indicator and/or a weed coverage indicator. Further indicators for weed treatment may be specific and/or resistant weed type or species indicator(s). In a further embodiment the operation parameter for disease treatment is determined based on critical disease indicator and/or a disease infestation indicator. In a further embodiment the operation parameter for insect treatment is determined based on critical insect species indicator and/or insect population or density indicator.

In a further embodiment the operation parameter is determined based on a historical distribution map of the agricultural area. The operation parameter may be separately determined for specific subareas or locations of the agricultural field indicated by the historical distribution map. The distribution map may be a biomass, disease or a weed distribution map. The biomass distribution map may include a biomass indicator such as leaf area index. The weed distribution map may include indicator regarding beneficial and critical weeds. The disease distribution map may include indicator regarding disease pressure.

In a further embodiment more than one operation parameter for different zones of the agricultural area or a spatially resolved map of operation parameters for different locations of the agricultural area are determined e.g. based on historic measurement data of the agricultural area to be treated.

In a further embodiment the control file comprises zone-specific or location-specific metadata relating to specific treatment products for specific zones, locations or sub-areas of the agricultural area. The determination or adjustment of the operation parameter may depend on a selection of treatment products for specific zones, locations or sub-areas of the agricultural area preferably as provided by the treatment data.

In a further embodiment the control file comprises one operation parameter for the agricultural area, more than one operation parameter for different zones of the agricultural area or a spatially resolved map of operation parameters for different locations of the agricultural area.

In a further embodiment the control file comprises additional control parameters to control operation of the treatment device on the agricultural area. Such parameters may include an application mode parameter to determine which operation mode the treatment device or individual treatment component(s) is/are going to be controlled in. In one embodiment application mode parameter may be zone-specific or location-specific. The application mode parameter may trigger an on/off operation mode for individual treatment components dependent on the monitored condition. Further examples of operation modes triggered via the operation parameter may comprise: one or more flat rate or broadcast operations in which the same quantity of a treatment product is applied over a defined total area across multiple or all treatment components, a variable rate application (VRA) operation in which, e.g. based on a map, a first quantity of a treatment product is applied over multiple sub-areas, such as a first subarea, a second subarea, etc., and/or a simple activation or deactivation mode of individual treatment components to perform treatment on the spot e.g. for spot spraying. Any such operation mode is performed by providing a corresponding control parameter set with respective control signal(s) for e.g. individual treatment components. Further, different operation modes may correspond to different application rates of the treatment product for one or more of the treatment component(s).

In a further embodiment treatment device configuration data is provided to the preparation system. Treatment device configuration data may comprise a device identification or a setup identification including e.g. monitoring configuration identification treatment configuration setting or a tank configuration setting indicating a single tank system or a multiple tank system of the treatment device. The control file may include a further layer of operation parameter(s) relating to the tank system of the treatment device to be operated. This allows tailored control of the treatment composition applied to the agricultural area. The determination of such operation parameter(s) may depend on the selection of treatment products or treatment product ingredients such as oil or water.

In a further embodiment treatment device configuration data relate to the monitoring configuration, such as the condition to be monitored and/or the quantity derived from the condition to be monitored, and are provided to the preparation system. Depending on the condition to be monitored a suitable operation parameter may be determined and provided. This ensures safety of the treatment operation by the treatment device. Additionally, such identification allows for operation parameters to be generated for different treatment device types with different monitoring components and associated control signal generation mechanisms.

Further control parameters may include treatment parameters relating e.g. to the treatment product, treatment product composition or product amounts required for treatment. Yet further control parameters may include location parameters specifying the boundary of the agricultural area, zone boundaries for zone-specific treatments or navigation parameters to guide the treatment device during treatment.

In a further embodiment the control file comprises a set of dynamic operation parameters for dynamic adjustment during treatment. Dynamic adjustments may comprise dynamic adjustments of the operation parameter. In other words, dynamic adjustment of the operation parameter refers to online adjustment of e.g. one static operation parameter as received by the preparation system is adjusted depending on the real-time and/or location specific conditions monitored. Such dynamic adjustments may be based on a vegetative indicator relating to real-time and/or location-specific conditions on the agricultural area. In this way, the operation of the treatment device can be dynamically controlled based on the treatment condition derived from real-time data, such as an image. The operation parameter concept including a basic, optionally static operation parameter, which is adapted as needed based on the vegetative indicator allows for dynamic adjustments in a very simple manner while requiring minimum processing power on board of the treatment device.

The vegetative indicator may be a plant indicator, a crop indicator, a weed indicator, an insect indicator or any combination thereof. In case of volunteer crops, e.g. those not cultivated in the present season, may be considered weed in certain scenarios. The vegetative indicator is an indicator reflecting certain conditions on the agricultural area based on real-time datasets collected during travel of the treatment device through the field. In one embodiment the plant indicator signifies a plant growth stage and/or a number of plants. Plant may be a crop and/or a weed. In a further embodiment the weed indicator may relate to weed specie or weed type, weed growth stage and/or number of weeds. In yet a further embodiment a crop indicator may alternatively or additionally be used as vegetative indicator relating to crop growth stage and/or number of crops. In yet a further embodiment the insect indicator may alternatively or additionally be used as vegetative indicator relating to insect species or insect type, insect population and/or number of insects.

### BRIEF DESCRIPTION OF THE DRAWINGS

Exemplary embodiments will be described in the following with reference to the following drawings:

FIG. 1 shows a distributed computing system including a treatment device and a control file preparation system, according to an embodiment.

FIG. 2 shows an example of a treatment device, according to an embodiment.

FIG. 3 shows a flow chart of the method for generating and providing the control file to operate the treatment device on the agricultural area to be treated in one embodiment.

FIG. 4 shows a flow chart of the method for operating a treatment device based on the control file in one embodiment.

### DETAILED DESCRIPTION OF EMBODIMENTS

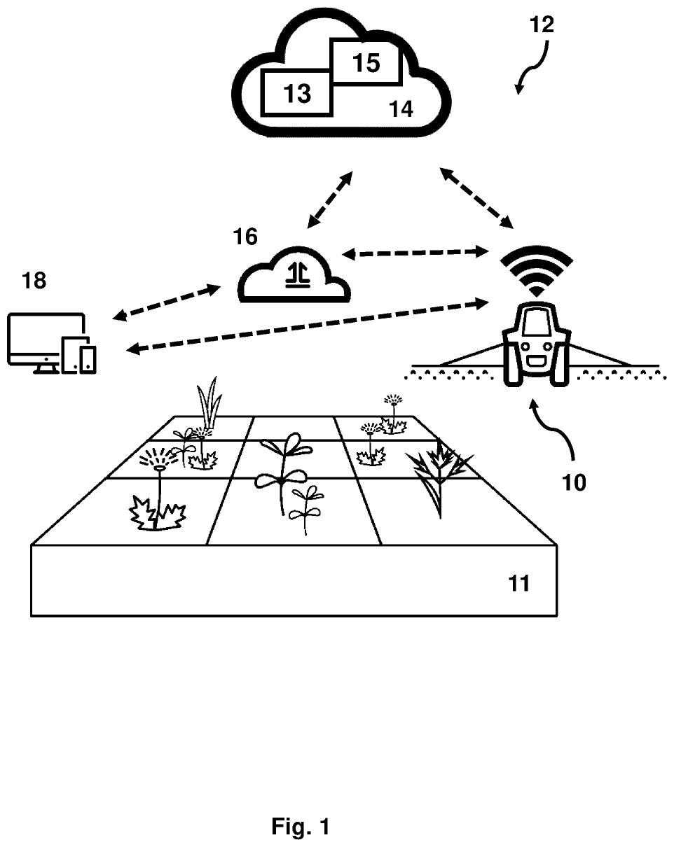

FIG. 1 shows a general overview of a distributed computing system 12 including a smart machinery 10 and a control file preparation system 14. The system 12 is configured for treatment of a field 11 with crops cultivated. The field 11 may to be treated by use of a treatment product, e.g. an herbicide, pesticide, insecticide, fungicide, or the like. Further, the field 11, may be any plant or crop cultivation area, such as a field, a greenhouse, or the like, at a geo-referenced location. As indicated in FIG. 1 by interlines, the field 11 may optionally be divided into two or more subareas illustrating zone-specific or location specific specificity.

The system 12 may form a distributed computing environment. It may comprise one or more of a smart machinery(s) 10, a first computing resource or means 14, a second computing resource or means 16, and a third computing resource or means 18. The smart machinery 10 and/or the first, second and third computing means 14, 16, 18, may at least partly be remote to each other. At least some of the smart machinery 10 and the first, the second and the third computing means 14, 16, 18 may comprise one or more of a data processing unit, a memory, a data interface, a communication interface, etc. Within the system 12, the smart machinery 10 and the first, the second and the third computing means 14, 16, 18 may be configured to communicate with each other via communication means, such as a communications network, as indicated in FIG. 1 by dashed lines between the entities 10, 14, 16 and 18.

The smart machinery 10 may also be referred to as a smart farming machinery. The smart machinery 10 may be e.g. a vehicle, such as a tractor or the like, an aircraft, a robot, a smart sprayer, or the like, and may be configured to be operated, for example, computer-aided, by a remote control and/or at least semi-autonomous. The smart machinery 10 may, for example, comprise and/or carry a treatment component, which may be e.g. a spraying device for application of a treatment product.

The first computing means 14 may be a farm management system configured to generate and/or provide a control file, which may comprise one or more control parameter(s) for operating the smart machinery 10, a control protocol, an activation code, one or more operation parameter(s), a decision logic for the smart machinery 10. The farm management system 14 may be configured to receive data from the smart machinery 10. Such data may also be provided and/or received through the second computing means 14. The farm management system 14 may include a preparation system 13 for generating a control file based on data provided by e.g. data base 15.

The second computing means 16 may be a data management system configured to send data to the smart machinery 10 and/or to receive data from the smart machinery 10. For example, the data received from the smart machinery 10 may comprise one or maps, such as a growth distribution map, a weed distribution map, or the like, which may be generated and/or provided based on data recorded during operation of the smart machinery 10 and/or application of the treatment product on the field 11. A preparation system may comprise the first and/or second computing means.

The third computing means 18 may be a client computer configured to receive client data from and/or to provide data to at least the first computing means 14, the second computing means 16, and/or the smart machinery 10. Such client data may, for example, comprise an application schedule for the treatment product to be applied on a specific agricultural area by operating the treatment device 120. Additionally or alternatively, the client data may comprise field analysis data to provide insights into the health state, weed information, plant or crop information, geo-location data, or the like, of a specific agricultural area.

Further, when data is monitored, collected and/or recorded by the treatment device 10, such data may be distributed to one or more of, or to every computing means 14, 16, 18 of the distributed computing system 12.

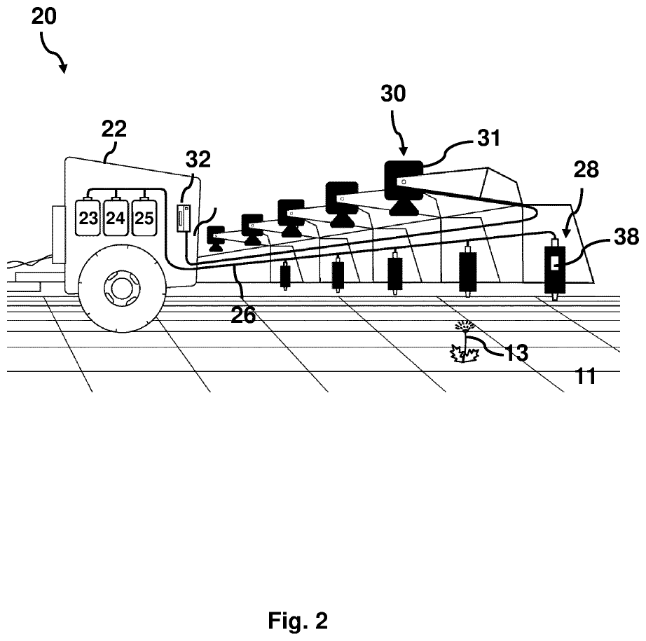

FIG. 2 shows an example of a treatment device 20, that includes spray nozzles 28 as treatment components. It is noted that FIG. 2 is merely schematic illustrating main components, wherein the treatment device 20 may comprise more or less components than shown.

The treatment device 20 is part of the smart machinery 10 (as shown in FIG. 1) for applying the treatment product on the field 11 or on one or more subareas thereof. The treatment device 20 may be releasably attached or directly mounted to the treatment device 10. In at least some embodiments, the treatment device 20 comprises a boom with multiple spray nozzles 28 arranged along the boom. The spray nozzles 28 may be fixed or may be attached movably along the boom in regular or irregular intervals. Each spray nozzle 28 may be arranged together with one or more, preferably separately, controllable valves 38 to regulate fluid release from the spray nozzles 28 to the field 11.

One or more tank(s) 23, 24, 25 are placed in a housing 22 and are in fluid communication with the nozzles 28 through one or more fluidic lines 28, which distribute the one or more treatment product(s) or composition ingredients like water 24, 25 to the spray nozzles 28. This may include chemically active or inactive ingredients like a treatment product or mixture, individual ingredients of a treatment product or mixture, a selective treatment product for specific weeds, a fungicide, a fungicide or mixture, ingredients of a fungicide mixture, ingredients of a plant growth regulator or mixture, a plant growth regulator, water, oil, or any other treatment product. Each tank 23, 24, 25 may further comprise a controllable valve to regulate fluid release from the tank 23, 24, 25 to fluid lines 28.

For monitoring and/or detecting, the treatment device 20 comprises a detection system 30 with multiple monitoring components 31 arranged along e.g. the boom. The monitoring components 31 may be arranged fixed or movable along the boom in regular or irregular intervals. The monitoring components 31 are configured to sense one or more conditions of the field 11. The monitoring components 31 may be an optical components 31 providing an image of the field.

Suitable optical monitoring components 31 are multispectral cameras, stereo cameras, IR cameras, CCD cameras, hyperspectral cameras, ultrasonic or LIDAR (light detection and ranging system) cameras. Alternatively or additionally, the monitoring components 31 may comprise further sensors to measure humidity, light, temperature, wind or any other suitable condition on the field 11.

In at least some embodiments, the monitoring components 31 may be arranged as shown in FIG. 2 with components 31 perpendicular to the movement direction of the treatment device 20 and in front of the nozzles 28 (seen from drive direction). In the embodiment shown in FIG. 2, the monitoring components 31 are optical monitoring components and each monitoring components 31 is associated with a single nozzle 28 such that the field of view comprises or at least overlaps with the spray profile of the respective nozzle 28 once the nozzle reach the respective position. In other arrangements each monitoring component 31 may be associated with more than one nozzle 28 or more than one monitoring component 31 may be associated with each nozzle 28.

The monitoring components 31, the tank valves and/or the nozzle valves are communicatively coupled to a control system 32. In the embodiment shown in FIG. 2, the control system 32 is located in a main housing 22 and wired to the respective components. In another embodiment monitoring components 31, the tank valves or the nozzle valves may be wirelessly connected to the control system 32. In yet another embodiment more than one control system 32 may be distributed in the treatment product application device housing 22 and communicatively coupled to monitoring components 31, the tank valves or the nozzle valves 38.

The control system 32 may be configured to control and/or monitor the monitoring components 31, the tank valves or the nozzle valves 38 based on a control file or operation parameter set provided by a control file and/or following a control protocol. In this respect, the control system 32 may comprise multiple electronic modules. One module for instance may be configured to control the monitoring components 31 to collect data such as an image of the field 11. A further module may be configured to analyze the collected data such as the image to derive parameters for the tank or nozzle valve control. A further module may be configured to receive the control file and the analyzed data to derive a control signal. Yet further module(s) may be configured to control the tank valves and/or nozzle valves based on such derived control signal.

As described above, the treatment device 20 comprises or is communicatively coupled to the image capturing device 31 and is configured to provide one or more images of the area of interest to the control system 32, e.g. as image data which can be processed by a data processing unit. It is noted that both capturing the at least one image by the image capturing device 31 and processing the same by the control system 32 is performed onboard or through communication means during operation of the treatment device 20, i.e. in real-time. It may further be noted that any other dataset than image data providing field conditions may be used.

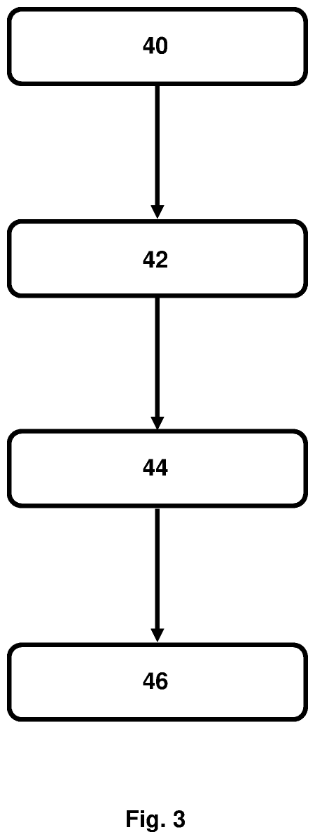

FIG. 3 shows a flow chart of the method for generating and providing the control file to operate the treatment device 20 on the field 11 to be treated.

In a first step 40, crop data relating to a crop present on the field 11 to be treated, optionally treatment data signifying a type of treatment to be conducted by the treatment device, and optionally environmental data related to the field 11 to be treated are provided to a preparation system 13, which is part of the farm management system 14.

The crop data, optionally the treatment data, and optionally the environmental data may be specific to the field 11 or may relate to specific characteristics of the field 11 to be treated. The crop data, optionally the treatment data, and optionally the environmental data may be provided to the preparation system by the farm management system 14. Treatment data, crop data and/or environmental data may be associated with location-specific characteristics of the field 11. Treatment data, crop data and/or environmental data may be associated with historic data collected for the field 11 stored e.g. in a farm management system 14.

The farm management system 14 may store data related to the field 11 to be treated. In particular, the farm management system 14 may store data relating to the location of the agricultural area. In other words, such data may relate to the area as such, to sub-areas of the agricultural areas 11 and/or to specific locations of the field 11. Such data may include crop rotation data, sowing maps, treatment maps, season treatment plans and measurement data collected for the agricultural area e.g. during previously executed treatment. Further examples of stored data include season plans for the current growing season, season plans relating to past growing seasons, measurement or monitoring data relating to past growing seasons and the current growing season.

Treatment data may include a specification of a treatment plan including for instance a treatment product, treatment product characteristics and/or its treatment timing per treatment action or a treatment sequence for multiple treatment actions.

Crop data may include a specification of the crop cultivated on the agricultural area including for instance a crop type indicator, crop trait indicator, a crop growth stage and/or a crop planting density, such as a row spacing between crop plants.

Environmental data may include historic weather data, forecasted weather data or historic measurement data relating to conditions on the agricultural area to be treated. Environmental data may include non-real-time recorded data and/or real-time recorded data, such as data from remote sensing equipment e.g. satellites, data from stationary equipment placed in the agricultural area, e.g. weather stations, soil sensors or the like, and/or data from sensors of the treatment device, e.g. temperature sensors, weather sensors, fluidic sensors, or the like. Such data may be associated with location-specific conditions or treatments on the field 11.

The farm management system 14 may further provide to the preparation system treatment device settings signifying the condition to be monitored for the specific device. This way the control file can be generated for different treatment devices with different monitoring components 31. Other data provided may by precipitation data in-season treatment indicators, weed, insect or disease spectrum. This may allow more tailored and targeted control file generation.

In a second step 42, the preparation system determines from the crop data, optionally the treatment data and optionally the environmental data at least one operation parameter, wherein the determined operation parameter is related to the real-time and/or location-specific condition to be monitored during treatment.

The operation parameter may be threshold, e.g. a weed threshold, impacting the operation mode of the treatment device 10 on the field 11. The operation mode of the treatment device may then depend on the monitored condition or a derived parameter being greater, greater or equal, equal, smaller or equal or smaller than the threshold. For instance, in weed treatment the threshold may relate to a fraction of weed objects present in an image, e.g. a weed coverage.

For insect treatment the threshold may relate to a fraction of insects present in the image. For disease treatment the threshold may relate to a fraction of fungal infestation present in the image. Here the fraction of pixels associated with weed, insect or fungal infestation may be derived from the image. For a percentage parameter the fraction of pixels associated with weeds, insects or fungal infestation may be related to all pixels or pixels not associated with weed, insect or fungal infestation. In operation of the treatment device, this may be calculated by the number of pixels assigned to weeds, insects, fungal infestation compared to the total number of pixels of the image. If the fraction is greater than or equals the threshold, an operation mode, such as an on-signal for the treatment component associated with the monitoring component, may be triggered.

The real-time and/or location-specific condition may be adjusted according to a type of the treatment device, for instance a type of treatment device as trailed sprayers that are connected to a tractor or self-propelled treatment devices.

The operation parameter may be determined based on different factors. For instance, for a given crop type indicator, crop trait indicator and a given treatment plan the operation parameter may be determined and further adjusted based on crop growth data.

The operation parameter may be determined based on precipitation data and one or more treatment product characteristic(s), The treatment product characteristic may relate to a residual characteristic and/or an efficacy characteristic. In combination with precipitation data such treatment product characteristics may be related to the agricultural area to be treated.

For instance, in weed treatment residues from residual herbicides of earlier treatments can play a role. Treatment products such as soil-applied or residual herbicides may be activated by precipitation. To determine or adjust the operation parameter with respect to prior treatment(s) historic precipitation data may be used. This may include to determine, if the season was wet or dry. Here a long-term historic precipitation averaged over multiple years may compared to a short-term historic precipitation averaged over couple of weeks prior to the planned treatment. If the long-term average is greater than the short-term average, the season may be dry and the operation parameter may be set accordingly. In the case of a residual herbicide applied prior to the treatment planned, the operation parameter may be set such that a spot sprayer may be more sensitive to weed coverage. More sensitive means the spot sprayer is switched on at lower weed coverage than signified e.g. by the basic operation parameter. If the long-term average is smaller than the short-term average, the season may be wet and the operation parameter may be set accordingly. In the case of a residual herbicide applied prior to the treatment planned, the operation parameter may be set such that a spot sprayer may be less sensitive to weed coverage.

In the case of forecasted precipitation data, the operation parameter may be determined or adjusted based on a forecasted precipitation after the treatment to be conducted and treatment product characteristics. If the forecasted precipitation from weather data signifies drought, no residual treatment product relying on activation via precipitation may be used. If the forecasted precipitation from weather data signifies low precipitation sufficient for e.g. activation, residual treatment product relying on activation via precipitation may be used.

The operation parameter may be determined based on one or more in-season treatment indicator(s) relating to one or more treatment(s) of the agricultural area or relating to the plant, insect or disease spectrum present on the agricultural area. Typical parameters are cover crop, volunteer plants from previous crop rotation, use of slurry or FYM, ploughing or minimum tillage. Such parameters may affect the operation parameter only once or each parameter may affect the operation parameter individually.

Additionally, in weed treatment the presence of problematic weeds may be provided in historic maps of the field or via imaging reference data taken in the field. Such weeds may for instance be resistant weeds. Weed hot spots from historic maps may be used to determine operation parameters valid for such hot spot zones. Additionally or alternative biomass maps may be used to determine zone specific operation parameters. Such biomass maps may be generated from remote sensing imagery by e.g. determining the leaf area index.

The determination of the operation parameter may include the determination of a basic operation parameter and/or an adjusted operation parameter, wherein the basic parameter may be determined based on crop growth data assigned to the agricultural area to be treated and the timing of treatment. Furthermore, advanced techniques for determining the operation parameter may be subject to an advanced service signified through a user identification.

The basic operation parameter can be generated as part of a basic subscription to the service generating the control file. Here the determination may depend on basic parameters like the crop type indicator or the crop trait indicator related to the agricultural area. The adjusted operation parameter can be generated as part of an advanced or premium subscription to the service generating the control file. The adjusted operation parameter may depend on basic parameters like the crop type indicator or the crop trait indicator related to the agricultural area and advanced parameters like plant growth data related to the agricultural area, precipitation data related to the agricultural area, one or more treatment product characteristic(s), at least one in-season treatment indicator relating to at least one treatment of the agricultural area or weed, insect or disease spectrum present on the agricultural area.

Determination of an adjusted operation parameter can include:
wherein crop type indicator and crop trait indicator are provided to the preparation system, wherein the adjusted operation parameter is determined based on crop type indicator and crop trait indicator, and
wherein precipitation data related to the agricultural area to be treated is provided to the preparation system, wherein the adjusted operation parameter is determined or adjusted based on precipitation data and one or more treatment product characteristic(s), or
wherein at least one in-season treatment indicator relating to at least one treatment of the agricultural area is provided to the preparation system, wherein the adjusted operation parameter is determined or adjusted based on the in-season treatment indicator, or
wherein weed, insect or disease spectrum present on the agricultural area is provided to the preparation system, wherein the adjusted operation parameter is determined or adjusted based on weed, insect or disease spectrum.

Determination of an adjusted operation parameter can alternatively include:
wherein crop type indicator and crop trait indicator are provided and precipitation data, at least one in-season treatment indicator or weed, insect and/or disease spectrum present on the agricultural area is provided to the preparation system, and
wherein the adjusted operation parameter is determined or adjusted based on crop type indicator and crop trait indicator as well as precipitation data, at least one in-season treatment indicator or weed, insect and/or disease spectrum present on the agricultural area.

In a third step 44, the preparation system generates the control file comprising the at least one operation parameter usable to operate the treatment device based on a real-time and/or location-specific condition to be monitored.

The control file may comprise one operation parameter for the agricultural area, more than one operation parameter for different zones of the agricultural area or a spatially resolved map of operation parameters for different locations of the agricultural area.

In a fourth step 46, the preparation system provides the control file via an interface to the treatment device.

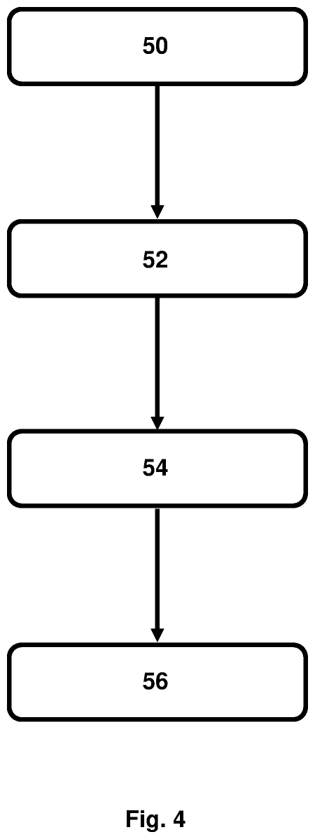

FIG. 4 shows a flow chart of the method for operating a treatment device based on the control file.

The preparation system 13 of the farm management system 14 is a remote computing resource communicatively coupled to the treatment device 10. In a fifth step 50, the control file is provided, via an interface, e.g. a data interface or communication interface, from the farm management system 14 to the treatment device 10 prior to treatment of the agricultural area. This way the transfer does not rely on connectivity of the treatment device 10 in the field 11.

In a sixth step 52, the real-time condition in the field 11 is monitored. The control file is used by the control system 32 of the treatment device 10. First data from real-time and location specific condition monitoring is analyzed and then respective control signals are determined in connection with the operation parameter. In a seventh step 54, the treatment component 28 is controlled based on the control signal derived from the operation parameter or control parameters provided in the control file. Based on the operation parameter provided by the farm management system 14 and the condition monitored by the treatment component 28 of the treatment device 10, the treatment component 28 is operated in a specific operation mode. Such operation mode may include location-specific spot spraying switching individual nozzles 28 on depending on the associated image taken by the camera 31. Alternatively, zone-specific spraying may include switching multiple nozzles 28 on depending on the associated images taken by the camera 31. Depending on the field conditions a flat rate application with all nozzles 28 on may be another operation mode. Advantageously, the control file may comprise a set of dynamic parameters for dynamic adjustment during treatment. This way static operation parameters provided by the control file may be dynamically adjustable during treatment depending on the conditions monitored in the field 11.

In a seventh step 56, the control signals, resulting activation of the treatment components 28 and/or sensed treatment execution, such as the amount of treatment product applied, may be saved in as-applied maps. Such maps may be provided to the farm or data management system 14, 16.

In another exemplary embodiment of the present invention, a computer program or a computer program element is provided that is characterized by being adapted to execute the method steps of the method according to one of the preceding embodiments, on an appropriate system.

The computer program element might therefore be stored on a computing system, which might also be part of an embodiment of the present invention. This computing system may be adapted to perform or induce a performing of the steps of the method described above. Moreover, it may be adapted to operate the components of the above described apparatus and systems. The computing system can be adapted to operate automatically and/or to execute the orders of a user. A computer program may be loaded into a working memory of a data processor. The data processor may thus be equipped to carry out the method of the invention.

This exemplary embodiment of the invention covers both, a computer program that right from the beginning uses the invention and a computer program that by means of an update turns an existing program into a program that uses the invention.

Further on, the computer program element might be able to provide all necessary steps to fulfil the procedure of an exemplary embodiment of the method as described above.

According to a further exemplary embodiment of the present invention, a computer readable medium, such as an ASIC, a storage chip, a RAM, a GPU or the like, is presented wherein the computer readable medium has a computer program element stored on it which computer program element is described by the preceding section.

A computer program may be stored and/or distributed on a suitable medium, such as an optical storage medium or a solid-state medium supplied together with or as part of other hardware, but may also be distributed in other forms, such as via the internet or other wired or wireless telecommunication systems.

However, the computer program may also be presented over a network like the World Wide Web and can be downloaded into the working memory of a data processor from such a network. According to a further exemplary embodiment of the present invention, a medium for making a computer program element available for downloading is provided, which computer program element is arranged to perform a method according to one of the previously described embodiments of the invention.

It has to be noted that embodiments of the invention are described with reference to different subject matter. In particular, some embodiments are described with reference to method type claims whereas other embodiments are described with reference to the device type claims. However, a person skilled in the art will gather from the above and the following description that, unless otherwise notified, in addition to any combination of features belonging to one type of subject matter also any combination between features relating to different subject matters is considered to be disclosed with this application. However, all features can be combined providing synergetic effects that are more than the simple summation of the features.

While the invention has been illustrated and described in detail in the drawings and foregoing description, such illustration and description are to be considered illustrative or exemplary and not restrictive. The invention is not limited to the disclosed embodiments. Other variations to the disclosed embodiments can be understood and effected by those skilled in the art in practicing a claimed invention, from a study of the drawings, the disclosure, and the dependent claims.

In the claims, the word “comprising” does not exclude other elements or steps, and the indefinite article “a” or “an” does not exclude a plurality. A single processor or other unit may fulfil the functions of several items re-cited in the claims. The mere fact that certain measures are re-cited in mutually different dependent claims does not indicate that a combination of these measures cannot be used to advantage. Any reference signs in the claims should not be construed as limiting the scope.

1. A method for generating a control file to operate a treatment device (10) on an agricultural area (11) to be treated, the method comprising:
providing (40) crop data relating to a crop present on the agricultural area (11) to be treated and treatment data signifying a type of treatment to be conducted by the treatment device (10) to a preparation system (13);
determining (42), by the preparation system (13), from the crop data and from the treatment data, at least one operation parameter, wherein the determined operation parameter is related to a real-time and/or location-specific condition to be monitored during treatment; and
generating (44), by the preparation system (13), a control file comprising the determined at least one operation parameter, the generated control file usable to operate the treatment device (10) based on the real-time and/or location-specific condition to be monitored during treatment.

2. The method of claim 1, further comprising:
providing (40) environmental data related to the agricultural area (11) to be treated to the preparation system (13), wherein the preparation system (13) uses the environmental data for determining the at least one operation parameter.

3. The method of claim 1, wherein the preparation system (13) is a remote computing resource communicatively coupled to the treatment device (10), and wherein the control file is provided (46), via an interface, to the treatment device (10) prior to treatment of the agricultural area (11).

4. The method of claim 1, wherein based on the at least one operation parameter and the real-time and/or location-specific condition to be monitored a treatment component of the treatment device (10) is to be operated in a specific operation mode.

5. The method of claim 1, wherein the crop data and/or the treatment data is specific to the agricultural area (11) to be treated.

6. The method of claim 1, wherein the crop data includes at least one of a crop type indicator, a crop trait indicator, and crop growth data, wherein the at least one operation parameter is determined based on at least one of the crop type indicator, the crop trait indicator, crop plant density and crop growth stage data.

7. The method of claim 1, wherein the at least one operation parameter is used for weed treatment and is determined based on a critical weed species indicator, a weed coverage indicator, a specific weed type or species indicator and/or a resistant weed type or species indicator.

8. The method of claim 1, wherein the determination of the at least one operation parameter includes the determination of a basic operation parameter and/or of an adjusted operation parameter.

9. The method of claim 8, wherein the basic operation parameter is determined based on crop type indicator or a crop trait indicator related to the agricultural area (11), and wherein the adjusted operation parameter is determined based on plant growth data related to the agricultural area (11), precipitation data related to the agricultural area (11), one or more treatment product characteristic(s), at least one in-season treatment indicator relating to at least one treatment of the agricultural area (11) or weed, insect or disease spectrum present on the agricultural area (11).

10. The method of claim 1, wherein the control file comprises as the determined at least one operation parameter an operation parameter for the agricultural area (11), more than one operation parameters for different zones of the agricultural area (11) or a spatially resolved map of operation parameters for different locations of the agricultural area (11).

11. The method of claim 1, wherein the control file comprises a set of dynamic operation parameter(s) for dynamic adjustment of the operation parameter(s) during treatment.

12. The method of claim 1, wherein treatment device configuration data are provided to the preparation system (13), wherein the treatment device configuration data relate to a monitoring configuration of the treatment device (10).

13. A preparation system (13) for generating a control file to operate a treatment device (10) on an agricultural area (11), wherein the preparation system (13) is configured to perform the method of claim 1.

14. A method for operating a treatment device (10) on an agricultural area (11), the method comprising:
providing (50), via an interface, a control file generated according the method of claim 1 to a control system;
monitoring (52) a real-time and/or location-specific condition; and
operating (54), via the control system, the treatment device (10) during treatment of the agricultural area based on the provided control file and the real-time and/or location-specific condition monitored.

15. A treatment device (10) for applying a treatment to an agricultural area, the treatment device (10) comprising:
an interface configured to provide a control file generated and/or provided according the method of claim 1 to a control system (32) of the treatment device (10);
at least one monitoring component (31) configured to provide a real-time and/or location-specific condition; and
the control system (32) communicatively coupled to the at least one monitoring component (31), wherein the control system (32) is configured to operate the treatment device (10) during treatment of the agricultural area (11) based on the provided control file and the real-time and/or location-specific condition.

16. (canceled)

17. (canceled)

18. A non-transitory computer-readable medium, having instructions stored thereon that, when executed by a control system, cause the control system to perform the method of claim 1.
